(19) United States
(12) Patent Application Publication
(10) Pub. No.: US 2015/0340737 A1
(43) Pub. Date: Nov. 26, 2015

(54) METHOD FOR PRODUCING ENERGY STORAGE DEVICE AND ENERGY STORAGE DEVICE

(71) Applicant: GS Yuasa International Ltd., Kyoto-shi (JP)

(72) Inventors: Tomonori KAKO, Kyoto (JP); Sumio MORI, Kyoto (JP); Akihiko MIYAZAKI, Kyoto (JP); Kenta NAKAI, Kyoto (JP)

(21) Appl. No.: 14/716,119

(22) Filed: May 19, 2015

(30) Foreign Application Priority Data
May 21, 2014 (JP) 2014-105086

(51) Int. Cl. H01M 10/0567; H01M 4/58; H01M 10/04; H01M 10/0525

(52) U.S. Cl. CPC H01M 10/0567; H01M 10/0525; H01M 4/5825; H01M 10/049; H01M 2004/028

(57) ABSTRACT

A method including: a placing step of placing an electrode assembly including a positive electrode that contains a positive active material and a negative electrode that contains a negative active material, and an electrolyte solution containing an additive in a container; a charging step of charging the electrode assembly placed in the container; and a hermetically sealing step of hermetically sealing the container after the charging step. When starting charging in the charging step, the electrolyte solution contains 1.0 mass % or less of lithium difluoro bis(oxalate)phosphate as the additive. The charge voltage in the charging step is 4.0 V or more.

### CROSS-REFERENCE TO RELATED APPLICATIONS

This application claims the benefit of Japanese patent application No. 2014-105086, filed on May 21, 2014, which are incorporated by reference.

### FIELD

The present invention relates to a method for producing an energy storage device and also to an energy storage device.

### BACKGROUND

Conventionally, various energy storage devices have been known. For example, an energy storage device including an electrode assembly, which includes a positive electrode that contains a positive active material and a negative electrode that contains a negative active material, an electrolyte solution, and a hermetically sealed container for storing the positive electrode, the negative electrode, and the electrolyte solution is known.

As an energy storage device of this kind, for example, one whose electrolyte solution contains lithium difluoro bis(oxalate)phosphate as an additive for coating the positive active material and the negative active material is known (JP-A-2005-32714).

In such an energy storage device, by charging at the time of use, a decomposition product of the additive is formed on the surface of the positive active material or the negative active material. Due to such a decomposition product or the like, a decrease in electric capacity associated with repeated charge-discharge, for example, is suppressed.

### SUMMARY

The following presents a simplified summary of the invention disclosed herein in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In the conventional energy storage device, along with the production of a decomposition product, as mentioned above, gases such as CO and CO₂ may be generated. This may raise the pressure in the container, resulting in the swelling of the hermetically sealed container.

An object of the present invention is to provide a method for producing an energy storage device which is capable of providing an energy storage device in which a decrease in electric capacity associated with repeated charge-discharge is suppressed, while the swelling of the container is suppressed. Another object is to provide an energy storage device in which a decrease in electric capacity associated with repeated charge-discharge is suppressed, while the swelling of the container is suppressed.

A method for producing an energy storage device according to an aspect of the present invention includes: a placing step of placing an electrode assembly including a positive electrode that contains a positive active material and a negative electrode that contains a negative active material, and an electrolyte solution containing an additive in a container; a charging step of charging the electrode assembly placed in the container; and a hermetically sealing step of hermetically sealing the container after the charging step. When starting charging in the charging step, the electrolyte solution contains 1.0 mass % or less of lithium difluoro bis(oxalate)phosphate as the additive. The charge voltage in the charging step is 4.0 V or more.

### BRIEF DESCRIPTION OF DRAWINGS

The foregoing and other features of the present invention will become apparent from the following description and drawings of an illustrative embodiment of the invention in which:

FIG. 1 is a drawing showing the appearance of a nonaqueous electrolyte secondary battery (lithium ion secondary battery) as an energy storage device.

FIG. 2 is a schematic diagram of an electrode assembly.

FIGS. 3A to 3C are cross-sectional views schematically showing the implementation of a placing step along the A-A cross-section of FIG. 1.

FIG. 4 is a schematic diagram showing a specific example of the implementation of a charging step.

FIG. 5 is a schematic diagram showing a specific example of the implementation of a hermetically sealing step.

### DESCRIPTION OF EMBODIMENTS

A method for producing an energy storage device according to an aspect of the present invention includes: a placing step of placing an electrode assembly including a positive electrode that contains a positive active material and a negative electrode that contains a negative active material, and an electrolyte solution containing an additive in a container; a charging step of charging the electrode assembly placed in the container; and a hermetically sealing step of hermetically sealing the container after the charging step. When starting charging in the charging step, the electrolyte solution contains 1.0 mass % or less of lithium difluoro bis(oxalate)phosphate as the additive. The charge voltage in the charging step is 4.0 V or more.

According to another aspect of the method for producing an energy storage device of the present invention, the positive active material may include a particle containing lithium iron phosphate, and a surface of the particle may be coated with a carbon material.

According to another aspect of the method for producing an energy storage device of the present invention, the charge voltage in the charging step may be 4.5 V or less.

An energy storage device according to another aspect of the present invention may include: an electrode assembly including a positive electrode that contains a positive active material and a negative electrode that contains a negative active material; and an electrolyte solution containing an additive.

The electrolyte solution contains 1.0 mass % or less of lithium difluoro bis(oxalate)phosphate as the additive. A decomposition product produced by charging from the additive is at least on a surface of the positive active material.

According to another aspect of the energy storage device of the present invention, the positive active material may include a particle containing lithium iron phosphate, and a surface of the particle is coated with a carbon material.

The method for producing an energy storage device according to the aspect has an effect that it is capable of providing an energy storage device in which a decrease in electric capacity associated with repeated charge-discharge is suppressed, while the swelling of the container is suppressed. The energy storage device according to the aspect also has an effect that it is suppressed in a decrease in electric capacity associated with repeated charge-discharge, while also suppressed in the swelling of the container.

Hereinafter, a method for producing an energy storage device according to one embodiment of the present invention will be described with reference to the drawings.

The method for producing an energy storage device of this embodiment includes: a placing step of placing an electrode assembly 4 including a positive electrode that contains a positive active material and a negative electrode that contains a negative active material, and an electrolyte solution containing an additive in a container 5; a charging step of charging the electrode assembly 4 placed in the container 5 before hermetically sealing the container 5; and a hermetically sealing step of hermetically sealing the container 5 after the charging step. When starting charging in the charging step, the electrolyte solution contains more than 0 mass % and 1.0 mass % or less of lithium difluoro bis(oxalate)phosphate as an additive. The charge voltage in the charging step is 4.0 V or more.

According to the production method of this embodiment, because the charge voltage in the charging step is 4.0 V or more, a decomposition product of lithium difluoro bis(oxalate)phosphate (hereinafter sometimes referred to as LiFOP) as an additive can be sufficiently formed on the surface of the negative active material. In particular, due to the charge voltage of 4.0 V or more, the decomposition product can be formed also on the surface of the positive active material, where the decomposition product is hardly formed at relatively low charge voltages. Accordingly, in a produced energy storage device, a decrease in electric capacity after repeated charge-discharge and a decrease in electric capacity with time can be suppressed. Further, the amount of remaining LiFOP in the electrolyte solution can be made relatively small, whereby the swelling of the container 5 associated with charging in use of the energy storage device can be suppressed.

When the charge voltage in the charging step is less than 4.0 V, a relatively large amount of LiFOP remains in the electrolyte solution after charging. That is, a relatively large amount of LiFOP remains undecomposed in the electrolyte solution after charging. Accordingly, in association with charging at the time of use, the remaining additive is decomposed, and the decomposition is followed by gas generation. As a result, the swelling of the container 5 associated with charging at the time of use may not be suppressed. In addition, the amount of decomposition product formed on the surfaces of the positive active material and the negative active material may be relatively small. Accordingly, a decrease in electric capacity associated with repeated charge-discharge or a decrease in electric capacity with time may not be suppressed.

In addition, according to the method for producing an energy storage device of this embodiment, in the charging step, a decomposition product of LiFOP can be formed not only on the surface of the negative active material but also on the surface of the positive active material. The decomposition product is, for example, a fluorine compound or a fluorine-based phosphate, and the surface distribution of the decomposition product may vary depending on the conditions. It is believed that when a decomposition product is formed not only on the surface of the negative active material but also on the surface of the positive active material, side reactions on the positive and negative electrodes, such as the decomposition of the electrolyte solution, are suppressed. Accordingly, a decrease in the electric capacity of the obtained energy storage device associated with repeated charge-discharge can be suppressed. Further, a decrease in the electric capacity of the obtained energy storage device with time can be suppressed.

In addition, according to the production method of this embodiment, in the charging step, a decomposition product of LiFOP can be formed not only on the surface of the negative active material but also on the surface of the positive active material. That is, the amount of LiFOP remaining in the electrolyte solution after charging can be reduced. Accordingly, gas generation from LiFOP associated with charging in use of the obtained energy storage device can be suppressed. As a result, the swelling of the container 5 can be suppressed.

When the electrolyte solution contains more than 1.0 mass % of LiFOP when starting charging in the charging step, a relatively large amount of additive may remain in the electrolyte solution even after charging. Accordingly, during charging in use of the energy storage device, relatively large amounts of gases, such as CO and CO₂, are generated by the decomposition of LiFOP Accordingly, the swelling of the container 5 associated with charging may not be suppressed. In addition, a decrease in electric capacity with time may not be suppressed.

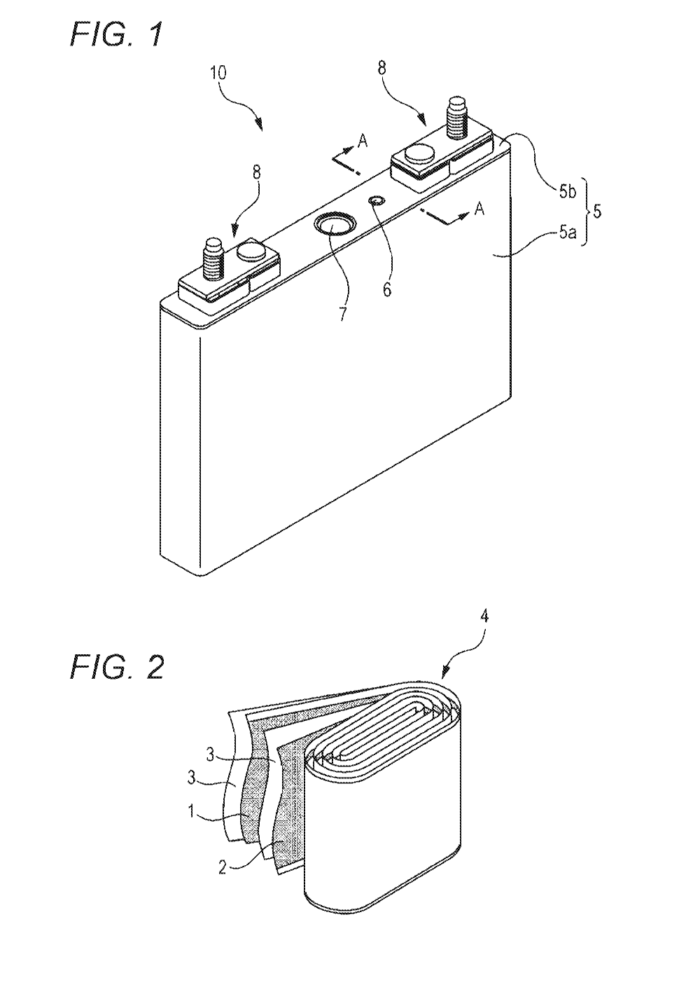

In the production method of this embodiment, for example, a nonaqueous electrolyte secondary battery 10 (lithium ion secondary battery 10) shown in FIG. 1 can be produced as an energy storage device.

The nonaqueous electrolyte secondary battery 10 produced by the method of this embodiment includes, as shown in FIG. 1, a hermetically sealable container 5 for placing an electrolyte solution and an electrode assembly 4 inside.

The electrolyte solution contains at least an electrolyte salt and a nonaqueous solvent, and further contains more than 0 mass % and 1.0 mass % or less of LiFOP at the start of charging in the charging step.

As shown in FIG. 2, for example, the electrode assembly 4 includes a sheet-like positive electrode 1 containing a positive active material, a sheet-like negative electrode 2 containing a negative active material, and a sheet-like separator 3 placed between the positive electrode 1 and the negative electrode 2 wound together.

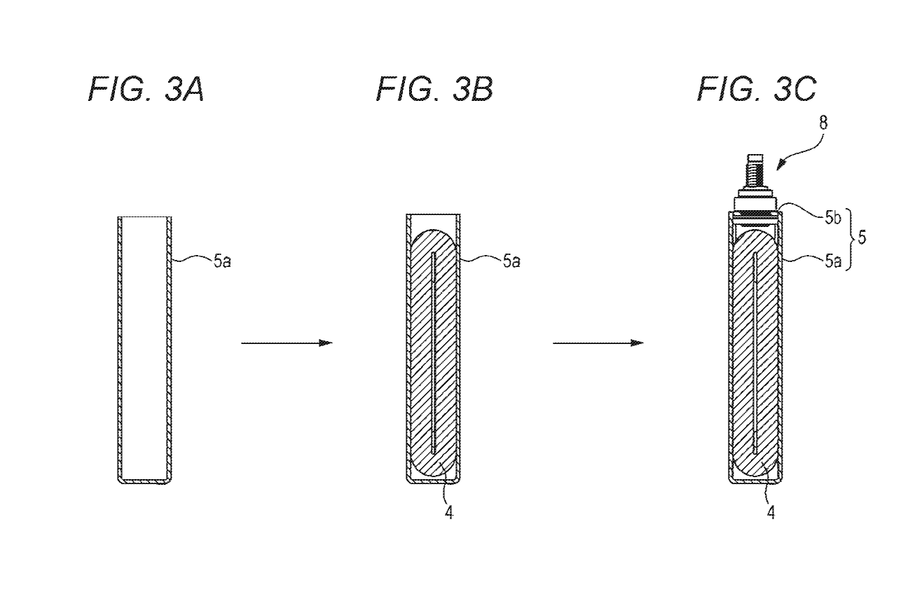

As shown in FIG. 1 and FIGS. 3A to 3C, the container 5 includes a container body 5a that is open to one direction and is for storing the electrode assembly 4 and the electrolyte solution, and a lid 5b for closing the opening of the container body 5a.

First, in the placing step, for example, as shown in FIG. 3A, the container body 5a of the container 5 is prepared.

Next, in the placing step, for example, as shown in FIG. 3B, the electrode assembly 4 is placed in the container 5 that is not hermetically sealed.

Specifically, in the placing step, for example, a sheet-like separator 3, a sheet-like positive electrode 1, and a sheet-like negative electrode 2 are laminated, and the obtained laminate is wound to form an electrode assembly 4. Then, the electrode assembly 4 in wound state is placed in the container body 5a of the container 5.

Subsequently, in the placing step, for example, as shown in FIG. 3C, the lid 5b is attached to the container body 5a having the electrode assembly 4 placed therein. That is, the opening of the container body 5a is closed with the lid 5b. Subsequently, an electrolyte solution containing an additive (LiFOP), an electrolyte salt, and a nonaqueous solvent is injected into the container 5.

Then, in the placing step, the electrode assembly 4 having the positive electrode 1 and the negative electrode 2 is brought into a state where it can be charged. That is, in the placing step, the uncompleted battery is brought into a state where it can be charged.

The positive electrode 1 has a particulate positive active material.

Specifically, the positive electrode 1 includes, for example, a positive current collector in the form of a sheet and a positive composite layer placed on each side of the positive current collector and containing the particulate positive active material.

The positive electrode 1 is in the form of a sheet, for example, as shown in FIG. 2.

Examples of the compound contained in the positive active material include lithium iron phosphate.

It is preferable that the positive electrode 1 has a particulate positive active material containing lithium iron phosphate. That is, it is preferable that the positive electrode 1 has particles containing lithium iron phosphate as a positive active material.

It is also preferable that the particles containing lithium iron phosphate contain 95 mass % or more of lithium iron phosphate.

Lithium iron phosphate contained in the positive active material is a compound containing at least phosphoric acid (PO₄), iron (Fe), and lithium (Li).

It is preferable that the lithium iron phosphate is a compound represented by the compositional formula LiFePO₄.

The lithium iron phosphate usually has an olivine crystal structure.

It is preferable that the positive active material is carbon-coated LiFePO₄ particles, in which particles containing lithium iron phosphate are surface-coated with a carbon material.

Specifically it is preferable that the positive active material has particles containing lithium iron phosphate and a film-like carbon material coating the particles. That is, it is preferable that the positive active material is in the form of particles, in which particles containing lithium iron phosphate are coated with a film-like carbon material.

It is preferable that the carbon material is in the form of a thin film to coat the entire surface of particles. That is, it is preferable that the carbon material is a thin layer and coats the entire surface of particles.

The surface coating with a carbon material can be achieved by a known method. Examples of the method include two-step methods, in which LiFePO₄ particles are produced and then coated with a carbon material, and one-step methods, in which LiFePO₄ particles and a carbon material to coat the particles are formed at the same time.

Examples of the two-step method include a method in which a carbon film is deposited on the surface of LiFePO₄ particles by the chemical vapor deposition (CVD) of propylene, and a method in which lactose and LiFePO₄ particles are mixed in a ball mill and heat-treated.

Examples of the one-step method include a method in which granular carbon, such as acetylene black or like carbon black or powder graphite, is subjected to a mechanochemical treatment together with a lithium iron phosphate material by ball-milling or the like, thereby forming LiFePO₄ particles and also directly depositing carbon thereon, followed by heating and baking, and a method in which organic matters such as glucose and ascorbic acid are used as raw materials of a carbon material, the raw materials are subjected to hydrothermal synthesis by microwave heating or ordinary heat-transfer heating, further followed by heating and baking.

The particle size of the positive active material is usually within a range of 5 to 20 μm. The particle size is determined by the measurement of particle size distribution.

The positive composite layer may further contain, as constituent components, a conducting agent, a binder, a thickener, and the like.

Conducting agents are not particularly limited, and examples thereof include natural graphite (flaky graphite, scaly graphite, earthy graphite, etc.), artificial graphite, carbon black, acetylene black, ketjen black, carbon whiskers, carbon fibers, and conductive ceramics.

The conducting agent may be one of the above or a mixture of two or more kinds, for example.

The binder is not particularly limited, and examples thereof include thermoplastic resins such as polytetrafluoroethylene (PTFE), polyvinylidene fluoride (PVDF), polyethylene, and polypropylene, ethylene-propylene-diene terpolymer (EPDM), sulfonated EPDM, styrene-butadiene rubber (SBR), and fluororubber.

The binder may be one of the above or a mixture of two or more kinds, for example.

The thickener is not particularly limited, and examples thereof include polysaccharides such as carboxymethyl cellulose and methyl cellulose.

The thickener may be one of the above or a mixture of two or more kinds, for example.

Examples of the material of the positive current collector include metals such as aluminum, titanium, stainless steel, and nickel.

In addition to metals, examples of the material of the positive current collector also include baked carbon, conductive polymers, and conductive glass.

The thickness of the positive current collector is not particularly limited, and is usually 10 to 30 μm.

In the placing step, the positive electrode 1 is produced by an ordinary method, such as the method described in the Examples below, for example.

That is, in the placing step, for example, a particulate positive active material, a conducting agent, a binder, and a thickener are mixed with an organic solvent such as alcohol or toluene. Next, the obtained liquid mixture is applied to each side of a sheet-like positive current collector. Then, the liquid mixture is dried to volatilize the organic solvent from the liquid mixture, thereby preparing a positive electrode 1 having a positive composite layer on each side of the positive current collector.

In the production of the positive electrode 1, as a method for mixing the above conducting agent, binder, thickener, and the like, a method of performing dry or wet mixing using a powder mixer, such as a V-shaped mixer, an S-shaped mixer, a grinder, a ball mill, or a planetary ball mill, is employed, for example.

Incidentally the positive active material is produced by an ordinary solid-phase baking method, coprecipitation method, of the like, for example.

The negative electrode 2 usually has a particulate negative active material.

Specifically, the negative electrode 2 includes, for example, a negative current collector in the form of a sheet and a negative composite layer placed on each side of the negative current collector. Then, the negative composite layer has the particulate negative active material.

The negative electrode 2 is in the form of a sheet, for example, as shown in FIG. 2.

The negative active material may be, for example, at least one kind selected from carbonaceous materials, lithium metal, alloys capable of occluding and releasing lithium ions (lithium alloys, etc.), metal oxides represented by the general formula MO_{z} (M represents at least one element selected from W, Mo, Si, Cu, and Sn, and z represents a numerical value within a range of 0<z≦2), lithium metal oxides (Li₄Ti₅O₁₂, etc.), and polyphosphate compounds.

The carbonaceous material may be, for example, at least one kind of graphite and amorphous carbon.

Examples of the amorphous carbon include non-graphitizable carbon (hard carbon) and graphitizable carbon (soft carbon).

The alloy capable of occluding and releasing lithium ions may be, for example, at least one lithium alloy selected from lithium-aluminum alloys, lithium-lead alloys, lithium-tin alloys, lithium-aluminum-tin alloys, and lithium-gallium alloys, or a Wood alloy.

As the negative active material, those commercially available are usable, for example.

As in the case of the positive composite layer, the negative composite layer may also contain the above binder, thickener, and the like as constituent components.

Examples of the material of the negative current collector include metals such as copper, nickel, iron, stainless steel, titanium, and aluminum.

In addition to metals, examples of the material of the negative current collector also include baked carbon, conductive polymers, and conductive glass.

The thickness of the negative current collector is not particularly limited, and is usually 5 to 30 μm.

In the placing step, for example, a negative electrode 2 is produced by the same method as in the production of a positive electrode mentioned above.

That is, in the placing step, for example, a particulate negative active material, a binder, and a thickener are mixed with an organic solvent, and then the obtained liquid mixture is applied to each side of a sheet-like negative current collector. Then, the applied liquid mixture is dried to volatilize the organic solvent from the liquid mixture, thereby preparing a negative electrode 2 having a negative composite layer on each side of the negative current collector.

In the placing step, usually, the positive electrode 1, the negative electrode 2, and an electrolyte solution are placed in the container 5, and the positive electrode 1, the negative electrode 2, and the electrolyte solution placed in the container 5 are brought into the same state as at the start of the charging step.

The electrolyte solution contains at least lithium difluoro bis(oxalate)phosphate (LiFOP). In addition to LiFOP, the electrolyte solution may further contain one or more kinds of other additives.

Examples of other additives include, but are not limited to, carbonates such as lithium tetrafluoro(oxalate)phosphate, lithium bis(oxalate)borate, lithium difluoro(oxalate)borate, difluoro lithium phosphate, vinylene carbonate, methyl vinylene carbonate, ethyl vinylene carbonate, propyl vinylene carbonate, phenyl vinylene carbonate, vinyl ethylene carbonate, divinyl ethylene carbonate, dimethyl vinylene carbonate, diethyl vinylene carbonate, and fluoroethylene carbonate; vinyl esters such as vinyl acetate and vinyl propionate; sulfides such as diallyl sulfide, allyl phenyl sulfide, allyl vinyl sulfide, allyl ethyl sulfide, propyl sulfide, diallyl disulfide, allyl ethyl disulfide, allyl propyl disulfide, and allyl phenyl disulfide; cyclic sulfonic acid esters such as 1,3-propanesultone, 1,4-butanesultone, 1,3-propenesultone, and 1,4-butenesultone; cyclic disulfonic acid esters such as methyl dimethylsulfonate, ethyl dimethylsulfonate, propyl dimethylsulfonate, ethyl diethylsulfonate, and propyl diethylsulfonate; sulfonic acid esters such as bis(vinylsulfonyl)methane, methyl methanesulfonate, ethyl methanesulfonate, propyl methanesulfonate, methyl ethanesulfonate, ethyl ethanesulfonate, propyl ethanesulfonate, methyl benzenesulfonate, ethyl benzenesulfonate, propyl benzenesulfonate, phenyl methanesulfonate, phenyl ethanesulfonate, phenyl propanesulfonate, methyl benzylsulfonate, ethyl benzylsulfonate, propyl benzylsulfonate, benzyl methanesulfonate, benzyl ethanesulfonate, and benzyl propanesulfonate; sulfurous acid esters such as dimethyl sulfite, diethyl sulfite, ethylmethyl sulfite, methyl propyl sulfite, ethyl propyl sulfite, diphenyl sulfite, methyl phenyl sulfite, ethyl phenyl sulfite, vinyl ethylene sulfite, divinyl ethylene sulfite, propylene sulfite, vinyl propylene sulfite, butylene sulfite, vinyl butylene sulfite, vinylene sulfite, and phenyl ethylene sulfite; sulfuric acid esters such as dimethyl sulfate, diethyl sulfate, diisopropyl sulfate, dibutyl sulfate, ethylene glycol sulfate, propylene glycol sulfate, butylene glycol sulfate, and pentene glycol sulfate; aromatic compounds such as benzene, toluene, xylene, fluorobenzene, biphenyl, cyclohexylbenzene, 2-fluorobiphenyl, 4-fluorobiphenyl, diphenyl ether tert-butylbenzene, ortho-terphenyl, meta-terphenyl, naphthalene, fluoronaphthalene, cumene, fluorobenzene, and 2,4-difluoroanisole; halogenated alkanes such as perfluoro octane; and silyl esters such as tris(trimethylsilyl)borate, bis(trimethylsilyl)sulfate, and tris(trimethylsilyl)phosphate. Incidentally, as the additive, the compounds mentioned above may be used alone, and it is also possible to use two or more kinds together.

Lithium difluoro bis(oxalate)phosphate contained in the electrolyte solution as an additive charges the electrode assembly 4, thereby forming a decomposition product on the surfaces of the positive active material and the negative active material. In addition, as a result of charging, this additive forms a decomposition product, and also generates gases such as CO and CO₂.

Lithium difluoro bis(oxalate)phosphate is a compound represented by the following formula (1).

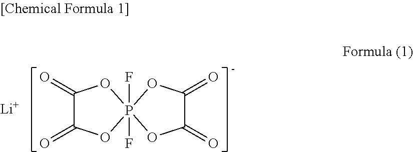

In addition, as additives, those commercially available are usable.

It is preferable that at the start of charging in the charging step, the electrolyte solution contains LiFOP as an additive in an amount of 0.2 mass % or more, more preferably 0.3 mass % or more, based on the total mass of the electrolyte solution. The presence of 0.2 mass % or more of LiFOP is advantageous in that a decrease in battery capacity associated with charge-discharge and a decrease in electric capacity with time can be more suppressed.

As the nonaqueous solvent contained in the electrolyte solution as a constituent component, those generally used in energy storage devices and the like may be employed.

Specifically, examples of the nonaqueous solvent, include cyclic carbonates, lactones, linear carbonates, linear esters, ethers, and nitriles.

Examples of the cyclic carbonate include propylene carbonate, ethylene carbonate, butylene carbonate, and chloroethylene carbonate.

Examples of the lactone include γ-butyrolactone and γ-valerolactone.

Examples of the linear carbonate include dimethyl carbonate, diethyl carbonate, and ethylmethyl carbonate.

Examples of the linear ester include methyl formate, methyl acetate, and methyl butyrate.

Examples of the ether include 1,3-dioxane, 1,4-dioxane, 1,2-dimethoxyethane, 1,4-dibutoxyethane, and methyl diglyme.

Examples of the nitrile include acetonitrile and benzonitrile.

Examples of the nonaqueous solvent, further include tetrahydrofuran and derivatives thereof, dioxolane and derivatives thereof, ethylene sulfide, sulfolane, and sultone and derivatives thereof.

The nonaqueous solvent may be, but is not limited to, one of the above or a mixture of two or more kinds, for example.

Examples of the electrolyte salt contained in the electrolyte solution as a constituent component include lithium salts such as LiClO₄, LiBF₄, LiAsF₆, LiPF₆, LiCF₃SO₃, LiN(SO₂CF₃)₂, LiN(SO₂C₂F₅)₂, LiN(SO₂CF₃)(SO₂C₄F₉), LiSCN, LiBr, LiI, Li₂SO₄, and Li₂B₁₀Cl₁₀.

The electrolyte salt may be, but is not limited to, one of the above or a mixture of two or more kinds, for example.

In order to obtain a battery having excellent, battery characteristics more reliably, it is preferable that the concentration of the electrolyte salt in the electrolyte solution is 0.5 to 1.5 mol/L, more preferably 0.8 to 1.2 mol/L.

The separator 3 may be, for example, a woven fabric, a nonwoven fabric, a microporous membrane, or the like that is insoluble in an organic solvent. The separator 3 may be, for example, composed of a woven fabric, a nonwoven fabric, or a microporous membrane alone, or of a combination thereof.

As the microporous membrane, synthetic resin microporous membranes made of a polyolefin resin, such as polyethylene, are preferable.

Examples of the synthetic resin microporous membrane include those made by laminating a plurality of microporous membranes that are different from each other in the kind of material, the weight average molecular weight of the synthetic resin, porosity and the like. Examples of the synthetic resin microporous membrane also include those containing appropriate amounts of various plasticizers, antioxidants, flame retarders, and the like, and those having an inorganic oxide, such as silica, applied to one or both sides thereof.

As the synthetic resin microporous membrane, polyolefin-based microporous membranes are preferable because they are moderate in terms of thickness, membrane strength, membrane resistance, and the like. Preferred examples of the polyolefin-based microporous membrane include microporous membranes made of polyethylene and polypropylene, microporous membranes made of polyethylene and polypropylene combined with aramid or polyimide, and microporous membranes made by combining these membranes.

The material of the separator 3 may be, for example, at least one kind of polyolefin-based resins such as polyethylene and polypropylene, polyester-based resins such as polyethylene terephthalate and polybutylene terephthalate, and fluorine-based resins.

The fluorine-based resin may be, for example, at least one kind selected from the group consisting of polyvinylidene fluoride, vinylidene fluoride-hexafluoropropylene copolymer, vinylidene fluoride-perfluorovinylether copolymer, vinylidene fluoride-tetrafluoroethylene copolymer, vinylidene fluoride-trifluoroethylene copolymer, vinylidene fluoride-fluoroethylene copolymer, vinylidene fluoride-hexafluoroacetone copolymer, vinylidene fluoride-ethylene copolymer, vinylidene fluoride-propylene copolymer, vinylidene fluoride-trifluoropropylene copolymer, vinylidene fluoride-tetrafluoroethylene-hexafluoropropylene copolymer, and vinylidene fluoride-ethylene-tetrafluoroethylene copolymer.

As shown in FIG. 1 and FIGS. 3A to 3C, for example, the container 5 includes a container body 5a in the form of a hollow cylinder or hollow prism and open to one direction, and a lid 5b in the form of a plate to close the opening of the container body 5a.

The container body 5a is usually placed such that the opening faces upward or sideways.

The lid 5b is formed such that its shape as seen from one side is approximately the same as the shape of the opening of the container body 5a. The lid 5b is also formed to hermetically close the opening of the container body 5a.

As shown in FIG. 1, for example, the lid 5b has formed therein an inlet 6 for injecting an electrolyte solution into the container 5 after closing the container body 5a with the lid 5b.

As shown in FIG. 1, for example, the lid 5b also has a safety valve 7 for preventing the container body 5a from rupture due to excessive pressure increase in the hermetically sealed container body 5a.

The container 5 is hermetically sealable and, for example, configured to be hermetically sealed by blocking the inlet 6 after injection of an electrolyte solution from the inlet 6.

Examples of the material of the container 5 include nickel-plated iron, stainless steel, aluminum, and metal-resin composite films.

Incidentally, as shown in FIG. 1, for example, the energy storage device (battery) 10 produced is configured such that it includes two terminals 8, and the two terminals 8 are electrically connected to the positive electrode 1 and the negative electrode 2, respectively.

The form of the nonaqueous electrolyte secondary battery 10 is not particularly limited, but a prismatic (flat) battery, which is originally prone to swell, is particularly preferable because battery swelling can be more suppressed.

An example of such a prismatic battery is the prismatic battery shown in FIG. 1, which includes an electrode assembly 4 including a positive electrode 1, a negative electrode 2, and a separator 3 wound together.

The charging step is performed after the placing step and before the container 5 is hermetically sealed. In the charging step, a voltage of 4.0 V or more is applied to the positive electrode 1 and the negative electrode 2 with the electrolyte solution containing more than 0 mass % and 1.0 mass % or less of LiFOP.

That is, at the start of charging in the charging step, the electrolyte solution contains more than 0 mass % and 1.0 mass % or less of LiFOP. In addition, charging in the charging step before the container 5 is sealed is performed at a constant current until the battery voltage reaches 4.0 V or more.

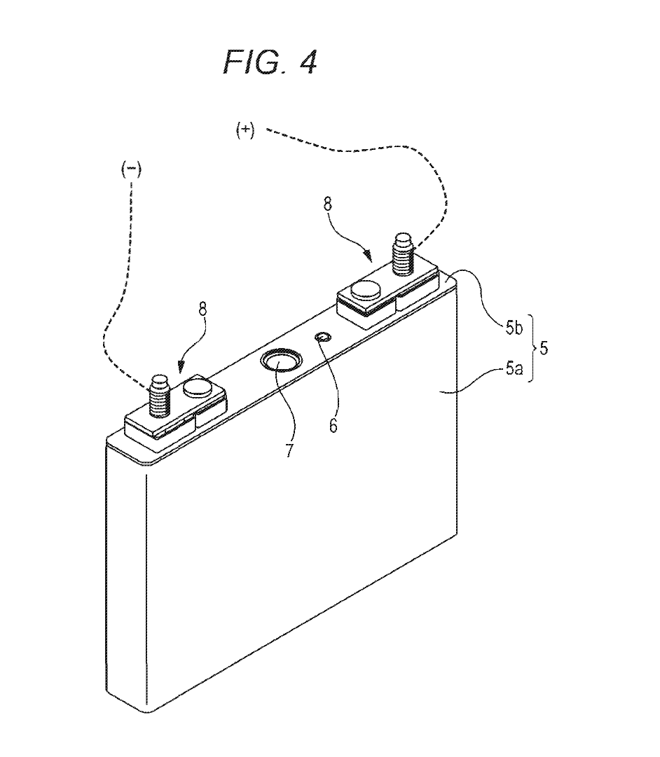

In the charging step, for example, as shown in FIG. 4, conducting wires (illustrated as dashed lines) are connected to the two terminals 8, respectively, and a voltage is applied to the conducting wires from the outside of the battery 10. Then, a current is passed between the positive and negative electrodes through the two terminals 8 to charge the energy storage device.

In the charging step, the additive (LiFOP) is decomposed as a result of charging, thereby generating gases such as CO and CO₂. However, because the container 5 is not hermetically sealed, the generated gases are discharged through the inlet 6 or the like into the air.

As a result of the charging step, a decomposition product of the additive (LiFOP) can be formed on the surfaces of the positive active material and the negative active material. Accordingly, as mentioned above, a decrease in the electric capacity of the obtained energy storage device with time can suppressed. In addition, as the additive (LiFOP) is decomposed, gas generation from the additive (LiFOP) associated with charging in use of the obtained energy storage device can be suppressed. As a result, the swelling of the container 5 can be suppressed.

In the charging step, the charge voltage is usually 4.5 V or less.

It is preferable that at the start of charging in the charging step, the LiFOP concentration of the electrolyte solution is 0.2 mass % or more, preferably 0.3 mass % or more, as mentioned above.

The charging step is usually performed at 10 to 25° C.

In the hermetically sealing step, after the charging step, the container 5 having the electrolyte solution and the electrode assembly 4 contained therein is hermetically sealed.

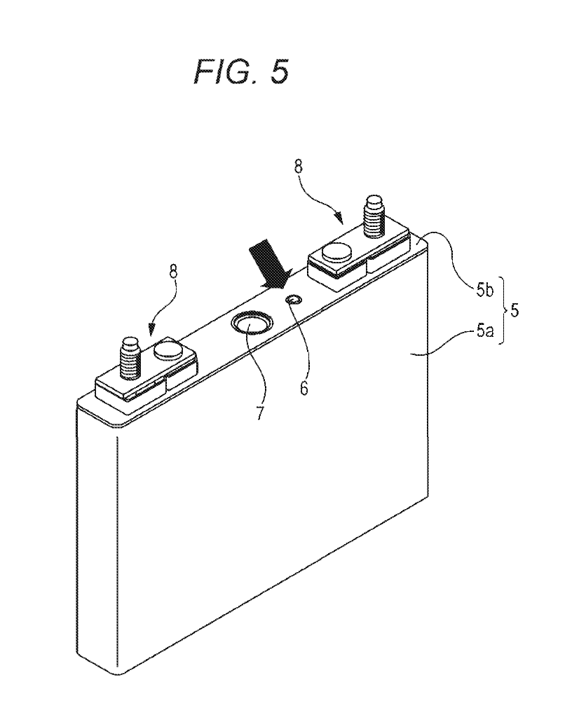

Specifically, in the hermetically sealing step, for example, the inlet 6 formed in the lid 5b (indicated by the thick arrow in FIG. 5) is sealed, thereby hermetically sealing the container 5.

Next, an energy storage device according to one embodiment of the present invention will be described.

An energy storage device of this embodiment includes: an electrode assembly including a positive electrode that contains a positive active material and a negative electrode that contains a negative active material; and an electrolyte solution containing an additive. The electrolyte solution contains 1.0 mass % or less of lithium difluoro bis(oxalate)phosphate (LiFOP) as the additive. A decomposition product produced from the additive (LiFOP) as a result of charging is on the surfaces of the positive active material and the negative active material.

That is, in the energy storage device of this embodiment, the electrolyte solution contains 1.0 mass % or less of lithium difluoro bis(oxalate)phosphate (LiFOP) as the additive, and a coating produced from the additive (LiFOP) as a result of charging is formed on the surfaces of the positive active material and the negative active material.

The energy storage device of this embodiment is an energy storage device produced by the method mentioned above, for example.

In the energy storage device of this embodiment, it is preferable that the positive active material is in the form of particles containing lithium iron phosphate surface-coated with a carbon material.

The method for producing an energy storage device and the energy storage device of this embodiment are as illustrated above. However, the present invention is not limited to the method for producing an energy storage device and the energy storage device illustrated above.

That is, as long as the effects of the present invention are not impaired, various modes used in general methods for producing an energy storage device and energy storage devices can be employed.

### EXAMPLES

Hereinafter, the present invention will be described in further detail with reference to examples. However, the invention is not limited to thereto.

### Example 1

The placing step, the charging step, and the hermetically sealing step were performed as shown below to produce an energy storage device (lithium ion secondary battery) shown in FIG. 1.

### 1. Placing Step

### (1) Production of Positive Electrode

As a positive active material, LiFePO₄ particles coated with a carbon material were used. Acetylene black was used a conductive auxiliary. PVDF was used as a binder.

N-methyl-2-pyrrolidone (NMP) as a solvent, the conductive auxiliary the binder, and the positive active material were mixed and kneaded in the following proportions: conductive auxiliary: 5 wt %, binder: 5 wt %, positive active material: 90 wt %, thereby producing a liquid mixture for positive electrode (positive electrode paste). Further, the produced positive electrode paste was applied onto an aluminum foil having a thickness of 15 μm. Application was performed so that the width of application and the width of the unapplied portion (a region having no positive active material formed) would be 83 mm and 11 mm, respectively and the coating weight after drying would be 14.1 mg/cm². After the application, the paste was dried, followed by roll-pressing. In addition, vacuum drying was performed to remove moisture.

### (2) Production of Negative Electrode

Graphitizable carbon was used as a negative active material. PVDF was used as a binder.

NMP as a solvent, the hinder, and the negative active material were mixed and kneaded in the following proportions: binder: 10 wt %, negative active material: 90 wt %, thereby producing a negative electrode paste. Further, the produced negative electrode paste was applied onto a copper foil having a thickness of 10 μm. Application was performed so that the width of application and the width of the unapplied portion (a region having no negative active material formed) would be 87 mm and 9 mm, respectively, and the weight after drying would be 7.4 mg/cm². After the application, the paste was dried, followed by roll-pressing. In addition, vacuum drying was performed to remove moisture.

### (3) Preparation of Electrolyte Solution

The electrolyte solution used was prepared by the following method. That is, an electrolyte salt was dissolved in a mixed solvent of ethylene carbonate (EC): dimethyl carbonate (DMC): ethylmethyl carbonate (EMC)=30:35:35 (volume ratio) to a final concentration of 1.0 mol/L. Further, lithium difiuoro bis(oxalate)phosphate (LiFOP) was added to the above mixed solvent in an amount of 1.0 mass % based on the total mass of the electrolyte solution, thereby preparing a liquid electrolyte solution.

### (4) Placement in Container

The placing step was performed by an ordinary method using the above positive electrode, the above negative electrode, the above electrolyte solution, a separator (microporous membrane made of polyethylene), and a container.

That is, a laminate having the separator placed between the above positive and negative electrodes was wound. Next, the wound laminate (electrode assembly) was placed in the container body of a prismatic battery case made of aluminum as the container (110 mm in width, 74 mm in height, 15 mm in thickness). Further, the positive electrode and the negative electrode were electrically connected to two terminals, respectively. Subsequently, a lid was attached to the container body. Then, the above electrolyte solution was injected into the container from an inlet formed in the lid of the container.

### 2. Charging Step

Constant current constant voltage charge at 4.0 V and a charge current of 2 A was performed for 3 hours.

### 3. Hermetically Sealing Step

The inlet of the container was sealed, whereby the container was hermetically sealed.

### Examples 2 to 7

Lithium ion secondary batteries were produced in the same manner as in Example 1, except that the LiFOP concentration in the electrolyte solution in the placing step and the charge voltage in the charging step were changed as shown in Table 1.

### Comparative Examples 1 to 13

Lithium ion secondary batteries were produced in the same manner as in Example 1, except that the LiFOP concentration in the electrolyte solution in the placing step and the charge voltage in the charging step were changed as shown in Table 1.

Table 1 shows the detailed configuration of the lithium ion secondary batteries produced in the examples and comparative examples.

TABLE 1

| | | | | Capacity | Capacity |
|---|---|---|---|---|---|
| | Charge | LiFOP | Battery | retention | retention |
| | voltage | amount | swelling | after | after |
| | [V] | [mass %] | [mm] | cycles [%] | standing [%] |
| Comparative | 3.5 | 1.0 | 1.3 | 71 | 71 |
| Example 1 | | | | | |
| Comparative | 3.9 | 1.0 | 0.4 | 74 | 74 |
| Example 2 | | | | | |
| Example 1 | 4.0 | 1.0 | 0.2 | 89 | 86 |
| Example 2 | 4.3 | 1.0 | 0.3 | 87 | 86 |
| Example 3 | 4.5 | 1.0 | 0.2 | 89 | 85 |
| Comparative | 3.5 | 0.0 | 0.8 | 65 | 60 |
| Example 3 | | | | | |
| Comparative | 3.9 | 0.0 | 0.2 | 63 | 58 |
| Example 4 | | | | | |
| Comparative | 4.0 | 0.0 | 0.3 | 64 | 60 |
| Example 5 | | | | | |
| Comparative | 4.3 | 0.0 | 0.1 | 62 | 57 |
| Example 6 | | | | | |
| Comparative | 3.5 | 1.1 | 1.5 | 73 | 69 |
| Example 7 | | | | | |
| Comparative | 3.9 | 1.1 | 1.4 | 75 | 70 |
| Example 8 | | | | | |
| Comparative | 4.0 | 1.1 | 1.0 | 72 | 67 |
| Example 9 | | | | | |
| Comparative | 4.3 | 1.1 | 0.8 | 71 | 68 |
| Example 10 | | | | | |
| Comparative | 3.5 | 0.3 | 0.9 | 71 | 65 |
| Example 11 | | | | | |
| Comparative | 3.9 | 0.3 | 0.6 | 72 | 66 |
| Example 12 | | | | | |
| Example 4 | 4.0 | 0.3 | 0.3 | 86 | 84 |
| Example 5 | 4.3 | 0.3 | 0.2 | 87 | 86 |
| Comparative | 3.5 | 0.2 | 0.7 | 69 | 66 |
| Example 13 | | | | | |
| Comparative | 3.9 | 0.2 | 0.8 | 71 | 65 |
| Example 14 | | | | | |
| Example 6 | 4.0 | 0.2 | 0.4 | 79 | 77 |
| Example 7 | 4.3 | 0.2 | 0.5 | 80 | 78 |

The lithium ion secondary batteries produced in the examples and comparative examples were evaluated as follows. That is, the produced batteries were each examined for battery swelling, the retention of electric capacity after repeated charge-discharge, and changes in electric capacity associated with the standing time (the retention of electric capacity after standing).

### Examination of Initial Discharge Capacity

Using each battery, first, initial discharge capacity was measured by the following method.

That is, with respect to each produced battery, in a thermostat at 25° C., constant current constant voltage charge at 3.5 V and a charge current of 5 A was performed for 3 hours, and, after a pause for 10 minutes, constant current discharge was performed at a discharge current of 5 A up to 2.0 V, thereby measuring the initial discharge capacity Q of the battery.

### Examination of Initial Battery Thickness (Battery Swelling)

After the examination of initial discharge capacity as above, in a thermostat at 25° C., constant current constant voltage charge at 2.90 V and a charge current of 2 A was performed for 1 hour. After a pause for 10 minutes, the battery was taken out from the thermostat, and the thickness T of the battery was measured.

Taking the initial battery thickness as T₀, battery swelling was calculated from T-T₀. Incidentally, initial battery thickness is the thickness of a battery before the above examination of initial discharge capacity.

### Charge-Discharge Cycle Test

In order to determine the test conditions for the charge-discharge cycle test, a battery adjusted to SOC 50% was maintained at 55° C. for 4 hours, subjected to constant current charge at 40 A to SOC 80%, and then subjected to constant current discharge at 20 A from SOC 80% to 10%, thereby determining the charge voltage V80 for SOC 80% and the discharge voltage V10 for SOC 10%.

### 1. Retention of Electric Capacity After Repeated Charge-Discharge

A cycle test at 55° C. was performed at a constant current of 20 A continuously without a pause, wherein the charge cutoff voltage was V80, while the discharge cutoff voltage was V10. The total cycle time was 3000 hours. After the completion of the 3000-hour cycle test, the battery was maintained at 25° C. for 4 hours and then subjected to the discharge capacity examination test as above. Taking the capacity before the cycle test (initial capacity) as Q1 and the capacity after the cycle test as Q2, the capacity retention after the cycle test was calculated from the following equation:

Capacity retention=Q2/Q1×100.

### 2. Retention of Electric Capacity After Standing

In a thermostat at 25° C., constant current constant voltage charge at 3.35 V and a charge current of 2 A was performed for 3 hours to set the SOC (State Of Charge) of a battery at 80%, and the battery was stored in a thermostat at 60° C. for 180 days (6 months). After storage for 180 days, each battery was cooled to 25° C., and then, in a thermostat at 25° C., discharged at a constant current of 2 A to an end voltage of 2.0 V. Subsequently the discharge capacity examination test as above was performed. Taking the capacity before the standing test (initial capacity) as Q1 and the capacity after the standing test as Q3, the capacity retention after the standing test was calculated from the following equation:

Capacity retention=Q3/Q1×100.

Table 1 shows the results of the swelling of the container (battery swelling), the retention of electric capacity after repeated charge-discharge, and the retention of electric capacity after standing determined as above.

As is understood from Table 1, in the batteries of the examples, the swelling of the container and a decrease in electric capacity associated with repeated charge-discharge were suppressed, and a decrease in electric capacity with time was also suppressed.

In addition, as is understood from Table 1, when the LiFOP content in the electrolyte solution was 0.3 mass % or more in the battery production in the examples, the swelling of the container was more suppressed. In addition, a decrease in the electric capacity of the obtained battery associated with repeated charge-discharge was more suppressed. In addition, a decrease in electric capacity with time was more suppressed.

Incidentally, although the charging step has been described before the hermetically sealing step in this embodiment, the charging step is not limited thereto and may be performed after the hermetically sealing step.

Further, another reason for the charge voltage of 4.0 V or more is that such a charge voltage is also effective in reducing micro-short circuits. One reason therefor is that when the charge voltage is 4.0 V or more, conductive impurities (metal) present between the electrodes can be dissolved, resulting in the reduction of micro-short circuits.

The additive of this embodiment may undergo a decomposition reaction as a result of voltage application, thereby generating gases, such as carbon dioxide and carbon monoxide. The decomposition reaction may occur under ambient reaction conditions except for the voltage application, and such gases may accumulate between the electrodes. As a result, a space is created between the electrodes, which may increase the possibility of contamination with impurities. This may result in the formation of micro-short circuits. Accordingly, it is preferable to take a measure, such as pressing the electrode assembly to drive out the gases between the electrodes, in and after the charging step. Examples of the method therefor include a method in which the electrodes (battery case) are pressed using a jig in the charging step, and a method in which a battery case is formed as assembled batteries, and the plurality of batteries are pressed by a restricting member.

What is claimed is:

1. A method for producing an energy storage device, comprising:
a placing step of placing an electrode assembly including a positive electrode that contains a positive active material and a negative electrode that contains a negative active material, and an electrolyte solution containing an additive in a container;
a charging step of charging the electrode assembly placed in the container; and
a hermetically sealing step of hermetically sealing the container after the charging step,
wherein when starting charging n the charging step, the electrolyte solution contains 1.0 mass % or less of lithium difluoro bis(oxalate)phosphate as the additive, and
a charge voltage in the charging step is 4.0 V or more.

2. The method for producing an energy storage device according to claim 1, wherein the positive active material includes a particle containing lithium iron phosphate, and
a surface of the particle is coated with a carbon material.

3. The method for producing an energy storage device according to claim 1, wherein the charge voltage in the charging step is 4.5 V or less.

4. An energy storage device comprising:
an electrode assembly including a positive electrode that contains a positive active material and a negative electrode that contains a negative active material; and
an electrolyte solution containing an additive;
wherein the electrolyte solution contains 1.0 mass % or less of lithium difluoro bis(oxalate)phosphate as the additive, and
a decomposition product produced by charging from the additive is at least on a surface of the positive active material.

5. The energy storage device according to claim 4, wherein the positive active material includes a particle containing lithium iron phosphate, and
a surface of the particle is coated with a carbon material.
